(19) United States
(12) Patent Application Publication
(10) Pub. No.: US 2006/0104235 A1
(43) Pub. Date: May 18, 2006

(54) Mixed mode wireless local area network terminal

(76) Inventors: Orjan Fritz, Hagersten (SE); Per Konradsson, Jarfalla (SE)

Correspondence Address: COATS & BENNETT, PLLC, P O BOX 5, RALEIGH, NC, 27602, US

(21) Appl. No.: 11/273,529

(22) Filed: Nov. 14, 2005

Related U.S. Application Data
(60) Provisional application No. 60/627,571, filed on Nov. 12, 2004.

(51) Int. Cl. H04Q 7/00

(52) U.S. Cl. 370/328

(57) ABSTRACT

A Wireless Local Area Network (WLAN) station/terminal operates in normally mutually exclusive infrastructure and independent modes. A mixed mode is added by means of a mixed mode means for running the WLAN terminal in the infrastructure and independent modes simultaneously.

This application claims the benefit of U.S. Provisional Application No. 60/627,571, filed Nov. 12, 2004, which is incorporated herein by reference.

### BACKGROUND

The present invention relates to Wireless Local Area Networks (WLAN).

Today, the connection between a WLAN terminal and a WLAN peripheral device is established via the Access Point of a communication network. This is because the IEEE 802.11 standard states that a device is either operating in Infrastructure mode (i.e. associated with an Access Point) or operating in Independent mode (i.e., direct connection between terminals without a central Access Point). This is further discussed in connection to FIGS. 1a and 1b.

The WLAN terminal needs to be connected in Infrastructure mode because it needs access to the LAN. The properties of the connection between the WLAN terminal and the WLAN peripheral are such that an Independent mode communication link is most effective and practical. A connection between two WLAN stations via an Access Point means that every packet needs to be transmitted over the air interface twice (from terminal 1 to AP and then from AP to terminal 2), while in Independent mode, each packet is transmitted directly from station 1 to station 2. Thus, connecting the WLAN peripheral to the WLAN using the Infrastructure mode results in ineffective utilization of available bandwidth.

In the prior art, the connection procedure is quite complicated if the connection between the terminal and the peripheral device is done via the Access Point. For example, a typical process would be (assuming the terminal is already associated with the Access Point): 1) The terminal leaves the Infrastructure association with the AP; 2) The terminal establishes an Independent association with the peripheral device; 3) Via an upper (proprietary) protocol, the terminal asks the peripheral device to leave the Independent association and instead associate with the Infrastructure network; 4) The peripheral device leaves the Independent network and associates with the Infrastructure network; and 5) The terminal leaves the Independent network and re-establishes the association with the Infrastructure network. After all that, the terminal and the peripheral device are ready to communicate via the Access Point.

One issue with the above is that it is unrealistic to require the presence of an Access Point every time the terminal needs to be connected to the peripheral device.

Thus, there remains a need for an alternative solutions that remain complaint with the communication standard.

### SUMMARY

The solution to the problem could generally be described as a logical split of the terminal unit into two logical units, where unit 1 operates in Infrastructure mode while unit 2 have an Independent association with the peripheral device and these two units are sometimes operating simultaneously by means of a mixed mode means for combining the two other mode and units.

In more detail, the invented WLAN terminal comprises one state-machine intended for controlling the WLAN terminal in WLAN terminal in the Infrastructure mode, a second state-machine for controlling the WLAN terminal in the Independent mode, and mixed mode means for running the first and second state-machines in a mixed mode, wherein the WLAN terminal is capable of transferring data information in the infrastructure and independent modes simultaneously.

Different embodiments of the present invention are described in the description and the independent claims.

The invention also relates to a method for operating a WLAN terminal in different modes, said WLAN terminal is capable of operating in one infrastructure mode or in a second independent mode, mutually exclusive, characterized by the step of setting the WLAN terminal in a mixed mode by means of a mixed mode means for running the WLAN terminal in the infrastructure and independent modes simultaneously.

The present invention also relates to a computer program and a computer program product.

With the proposed solution (assuming the terminal is already associated with the Access Point), what instead happens is:—The terminal establishes an Independent relation with the peripheral device. The terminal and the peripheral device will have the possibility to communicate directly without the intermediate Access Point.

As the peripheral device need only support Independent operation mode, and thus the implementation may be more compact with smaller memory footprint. The crypto key management is simplified as the peripheral device otherwise would need to be provided with keys for the Infrastructure connection (possibly different keys for each different Access Point).

The proposed invention is compliant with the 802.11 standard. There is a proposed amendment by the IEEE organization (802.11e) that addresses the same problem with a different solution (Direct Links). The strength of the proposed invention is still that the connection between the terminal and the peripheral device does not require the presence of an Access Point that comply with the 802.11e amendment of Direct Links.

### BRIEF DESCRIPTION OF THE DRAWINGS

FIGS. 1a and 1b are schematic block diagrams illustrating a communication network, a peripheral device and a prior art WLAN terminal operating according to the IEEE standard 802.11.

FIG. 2 is a schematic block diagram illustrating a communication network, a peripheral device and a WLAN terminal operating according to the invention.

### DETAILED DESCRIPTION

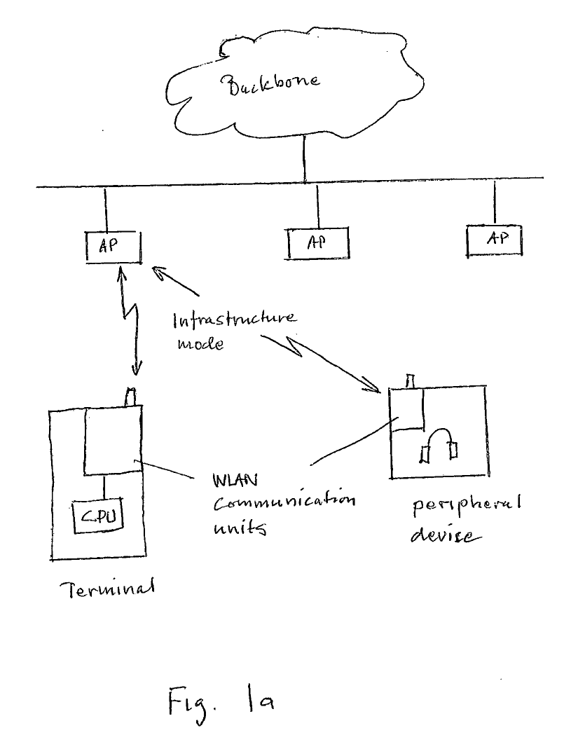

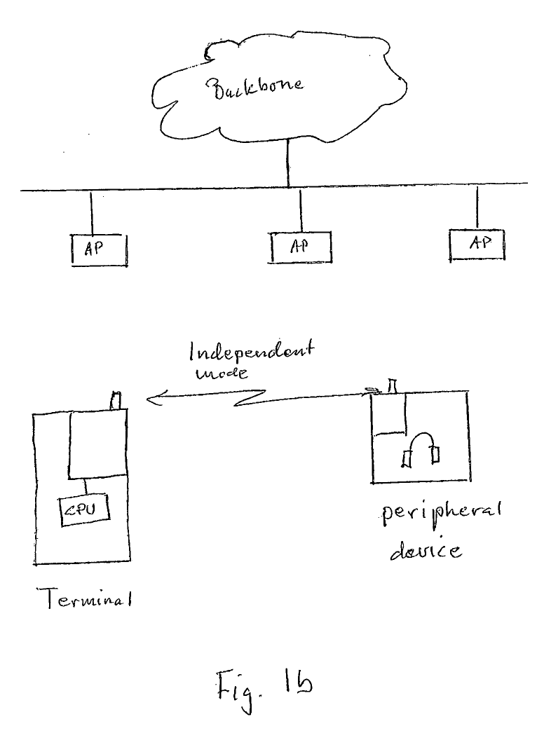

FIG. 1a and 1b are schematic block diagrams illustrating a prior art WLAN terminal operating according to the IEEE standard 802.11, which hereby is incorporated by reference.

In FIG. 1a the WLAN terminal, even generally denoted as a WLAN station, is operating in the infrastructure mode connected to an Access Point (AP) of a communication network. In the infrastructure mode according to the IEEE standard 802.11, peripheral devices, e.g. headset for mobile terminals, PAN, Personal Computers etc, has to be accessed from the WLAN terminal via an Access Point (AP), if the WLAN terminal is running in the infrastructure mode. The WLAN terminal and the peripheral device each one comprises a WLAN communication unit for transmitting and receiving data packages over an air interface. If the WLAN terminal is a mobile radio telecommunication terminal running a voice-over-IP call, this has to be done in the infrastructure mode and a wireless headset has also to be connected to the terminal via the Access Point AP. The WLAN terminal is not capable of running a direct link or connection over the air interface in this mode. The terminal is also provided with at least one computer or digital processing unit, such as a central processing unit (CPU), connected to In/Out-units and program software and data storage means (not shown) for controlling the functions, different equipment units and other applications of the terminal.

In FIG. 1b, the WLAN terminal is connected directly over a wireless link or wireless connection to the peripheral device, and the WLAN terminal is operating in the independent mode. It will not be possible to connect the WLAN terminal to an Access point without terminating the direct air interface link to the peripheral WLAN device.

The terminal and the peripheral device is forced to operate in the same mode, or state.

The WLAN communication unit comprises two state-machines, one state-machine operating exclusively in the infrastructure mode, and a second state-machine operating exclusively in the independent mode.

Hence, the two state-machines operates mutually exclusive. A state-machine is typically a computer program software in combination with a digital processing unit/device (processor). Different state-machines can be implemented as different software on the same processor.

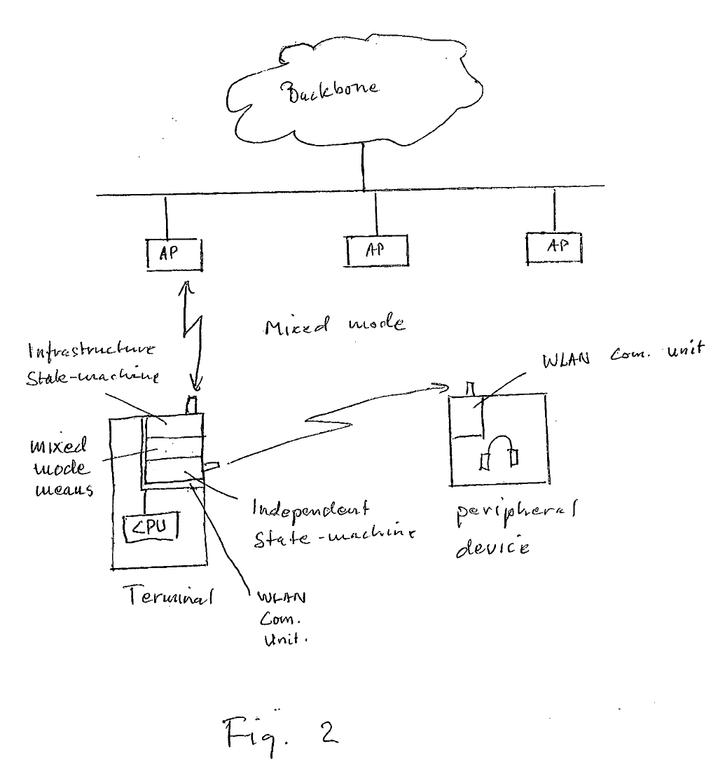

In FIG. 2, a WLAN terminal according to the invention is illustrated, which is capable of operating in a third, mixed mode, combining infrastructure mode and independent mode. A WLAN terminal according the invention will also comprise a two state machines capable of operating mutually exclusive. However, a WLAN terminal according to the invention will comprise a mixed mode means for running the first and second state-machines at the same time, thus making it possible to operate the WLAN terminal in a mixed mode combining the infrastructure mode and the independent mode. This third mode is comparable in many features to the scatter mode known from the Bluetooth standard, which hereby is incorporated by reference, but with the difference that the hardware and software is adapted to WLAN technology and structure. As illustrated in FIG. 2, the WLAN terminal is connected directly over a wireless link or wireless connection to the peripheral device operating in the independent mode, and at the same time, simultaneously, connected to an AP of a communication network. This mode is selectable by a user of the terminal if the user wants to use a peripheral device, such as a head set, in combination with the terminal, such as a mobile radio telecommunication terminal.

By means of the mixed mode means, the terminal and the peripheral device may therefore operate in different modes, or states. To achieve said operation possibility, the mixed mode means which comprises following means:

1. TSF means: The network timing functionality (TSF, Time Synchronization Function) in the station needs to simultaneously keeping track of two independent and mutual disjoint and asynchronous time reference domains. This is solved by implementing two virtual soft TSF means and separating them from the physical TSF timer in the station;

2. Network attribute list: The station needs to simultaneously be able to handle two different network segments, each with its own cell attribute list. This is done by keeping multiple (2) instances of network attribute lists. The network attribute list contain information such as allowed transmission rates, security policy, quality of service policy, beacon transmission timing, network id, etc.

3. Transmit timing accelerator means: In particular, the station needs to simultaneously be able to comply to two different sets of media access timing rules. This is done by hardware support in terms of multiple hardware transmit timing accelerator means, each with its own set of controlling parameters;

4. MAC address means: The station need to be able to, over one single physical interface, present two different network interfaces to the to the host environment in which it operates. This is done by simultaneously maintaining two different MAC addresses and, in the host driver part, announce two different and simultaneous network connections;

5. Different power management state machines: In cases where the two different networks are operating on different radio channels, and due to the fact that the proposed solution only requires one single radio module, and in order not to loose any incoming data, the station need to inform network peer units of the stations momentarily availability to communication. This is done by keeping and coordinating different power management state machines, one for each network instance.

When setting up a wireless communication link or connection, there is some properties of the connection to the AP which are announced via the data information signaling of the connection establishment. Said property information will be stored in data storing means within the terminal. As protocol is used for the data information transmission, capability information will be used in the lowest protocol level, controlling the timing of the protocols. This timing derived from the infrastructure mode connection, which also sometimes is denoted infrastructure network, is also used for controlling the establishment of the timing in independent mode connection, which also is denoted independent network. In this way, one connection or network is characterized as superior, and the other connection or network is subordinate. Hence, the infrastructure network is superior to the independent network. The hardware in the terminal has to support both connections/networks. The capability properties are therefore filtered out from the superior network to be used in the subordinate network for achieving that the two networks will be as compatible as possible. A routing means is therefore provided within the terminal according to the invention for accomplishing correct distribution of the data frames/packages to the networks respectively.

The peripheral device need only support Independent operation mode, and the implementation may be more compact with smaller memory footprint.

During the establishing of the different connection following synchronization measures will be performed. In the infrastructure mode connection/network, the WLAN terminal will correspond to a client party and the AP the server party. The peripheral device will be passive waiting for the establishment of a connection. In the independent mode, if a terminal or a peripheral device doesn't discover any synchronizer, it will immediately take the synchronizer function by starting beacon signaling. Due to the timer change and/or disturbance, synchronizer function is able to jump, be transferred, from one terminal/device to another device/terminal.

One benefit with the present invention is that it possible to connect a number of headsets to the same WLAN terminal and thereby establishing conference calls with a number of participants.

The present invention is not limited to the above-described preferred embodiments. Various alternatives, modifications and equivalents may be used. Therefore, the above embodiments should not be taken as limiting the scope of the invention, which is defined by the appended claims.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A Wireless Local Area Network (WLAN) terminal operative in two mutually exclusive modes: an Infrastructure mode and an Independent mode, comprising:
a first state-machine controlling the WLAN terminal in the Infrastructure mode;
a second state-machine controlling the WLAN terminal in the Independent mode;
a mixed mode means for running the first and second state-machines in a mixed mode, wherein the WLAN terminal is capable of transferring data information in the infrastructure and independent modes simultaneously in said mixed mode.

2. The WLAN terminal according to claim 1 wherein the mixed mode means comprises hardware controlling the timing and other properties so that the WLAN terminal, in said mixed mode, is able to operate in two different networks simultaneously and is able to transfer data information in the infrastructure and independent modes simultaneously.

3. The WLAN terminal according claim 2 wherein the mixed mode is a scatter mode adapted for and working according to WLAN technology and standard.

4. The WLAN terminal according to claim 1 further comprising a digital processor unit (CPU), and wherein the mixed mode means comprises software loaded in said CPU that controls the timing and other properties so that the WLAN terminal, in said mixed mode, is able to operate in two different networks simultaneously and is able to transfer data information in the infrastructure and independent modes simultaneously.

5. The WLAN terminal according claim 4 wherein the mixed mode is a scatter mode adapted for and working according to WLAN technology and standard.

6. The WLAN terminal according to claim 1 further comprising a routing means for distributing communicated data packages or frames.

7. A method for operating a Wireless Local Area Network (WLAN) terminal in different modes, including mutually exclusive infrastructure and independent modes, comprising: setting the WLAN terminal in a mixed mode by means of a mixed mode means for running the WLAN terminal in the infrastructure and independent modes simultaneously.

8. The method of claim 7 further comprising loading software into a digital processor unit (CPU) of the WLAN terminal, said software operative to control the timing and other properties so that the WLAN terminal, in said mixed mode, is able to operate in two different networks simultaneously and is able to transfer data information in the infrastructure and independent modes simultaneously.

9. The method of claim 7 further comprising providing hardware in said WLAN terminal operative to control the timing and other properties so that the WLAN terminal, in said mixed mode, is able to operate in two different networks simultaneously and is able to transfer data information in the infrastructure and independent modes simultaneously.

10. The method of claim 7 wherein said mixed mode corresponds to a scatter mode adapted for and working according to WLAN technology and standard.

11. A computer program product comprising a computer usable medium and a software code means loadable into an internal memory storage of a data processing unit within a controller of a WLAN terminal; said software code means operative, when loaded in said data processing unit, to allow the WLAN terminal to operate in a mixed mode wherein the WLAN terminal is operative to transfer data information in mutually exclusive infrastructure and independent modes simultaneously.

12. The computer program product according to claim 11 wherein the computer usable medium comprises one or more elements selected from the group consisting of a record medium, a hard disk, a floppy disk, a floppy disk drive, an optical disk drive, a computer memory, a Read-Only Memory, a magnetic cassette, a flash memory card, a digital video disk, random access memory, and an electrical carrier signal.

13. A computer program comprising software code means stored on a computer usable medium, from which the software code means is readable by a computer means, said software code means operative, when loaded in a data processing unit within a controller of a WLAN terminal, to allow the WLAN terminal to operate in a mixed mode wherein the WLAN terminal is operative to transfer data information in mutually exclusive infrastructure and independent modes simultaneously
